(19) United States
(12) Patent Application Publication
(10) Pub. No.: US 2014/0320441 A1
(43) Pub. Date: Oct. 30, 2014

(54) TOUCH PANEL AND ELECTRIC DEVICE

(71) Applicant: SHARP KABUSHIKI KAISHA, Osaka-shi, Osaka (JP)

(72) Inventors: Chiemi Yamada, Osaka-shi (JP); Yuhji Sugiyama, Osaka-shi (JP); Takashi Umemoto, Osaka-shi (JP); Takashi Ueno, Osaka-shi (JP); Takayuki Koyama, Osaka-shi (JP); Kazuyoshi Morimoto, Osaka-shi (JP); Tomohiro Yanagawa, Osaka-shi (JP)

(21) Appl. No.: 14/362,030

(22) PCT Filed: Nov. 30, 2012
(86) PCT No.: PCT/JP2012/081099

§ 371 Date: May 30, 2014

(30) Foreign Application Priority Data
Dec. 1, 2011 (JP) 2011-263529

(51) Int. Cl. G06F 3/041

(52) U.S. Cl. CPC G06F 3/0412; G06F 3/041; G06F 2203/04103
USPC 345/173

(57) ABSTRACT

A touch panel includes one transparent substrate. The transparent substrate includes: a main-region for detecting a touched two-dimensional location, the main region including a two-dimensional touch sensor that detects the touched two-dimensional location; and at least one sub region for detecting whether or not a touch has been done, the sub region including a one-layer-structured touch sensor. In the two-dimensional touch sensor, a main-side insulating layer is provided between an earlier-formed portion and a later-formed portion. Accordingly, the touch panel can be configured such that the main-side insulating layer and a sub-side insulating layer can be formed in the same step and the later-formed portion and the one-layer-structured touch sensor can be formed in the same step when a paint film layer having an icon drawn is provided in the sub region and the sub-side insulating layer is provided between the paint film layer and the one-layer-structured touch sensor.

### TECHNICAL FIELD

The present invention relates to a touch panel and as electric device, in particular, a touch panel suitable to be included in an electric device and an electric device including the touch panel.

### BACKGROUND ART

FIG. 9A is a front view for illustrating a first layer structure of a touch panel prior to the present invention. FIG. 9B is a cross sectional view taken along A-A. FIG. 9C is a cross sectional view taken along B-B. FIG. 10A is a front view for illustrating a second layer structure of a touch panel prior to the present invention. FIG. 10B is a cross sectional view taken along C-C. FIG. 10C is a cross sectional view taken along D-D. Referring to FIG. 9A to FIG. 9A and FIG. 10A to FIG. 10C, a mobile terminal such as a smartphone is provided with a display portion and an icon portion disposed below the display portion and permitting a predetermined operation as shown in FIG. 9A and FIG. 10A so as to detect both a touch on the display portion and a touch on the icon portion using a detection region in each of touch panels 160A, 160B.

Here, in touch panels 160A, 160B, icon marks in the icon portions are formed on glass substrates 181A, 181B using black mask layers (hereinafter, referred to as “BM layers”) 182A, 182B, respectively.

With such a configuration, a sensor can serve for both the display portion and the icon portion in each touch panel 160A, 160B and the icon marks can be included therein.

However, this configuration has the following problem. That is, BM layers 182A, 182B contain a conductive substance such as carbon and plural lines of ITO-1 layers 183A, 183B are directly in contact with BM layers 182A, 182B. This affects sensor performance in touch panels 160A, 160B.

In order to address problems such as occurrence of incorrect operation or non operation due to the electric conductivity of the carbon material powders contained in such a black ink, it is considered to use an insulative black ink as the marking ink as indicated in Japanese Patent Laying-Open No. 2009-295365 (hereinafter, referred to as “Patent Document 1”). In this way, even when the black marking ink is used for the touch panel, the sensor performance in the touch panel can be less affected.

However, in this case, a degree of freedom is decreased in terms of the material of the ink and the color tone of the ink, disadvantageously. In the case where the touch sensors are formed on BM layers 182A, 182B formed on glass substrates 181A, 181B respectively, disconnection may take place due to level differences at BM layers 182A, 182B. Hence, each of BM layers 182A, 182B desirably has a thickness thinner than 10 μm to 20 μm, which is a thickness when solidly painting the ink. In such a case, if the degree of freedom in selecting an ink is low, it becomes more difficult to select an ink that exhibits a desired performance.

In order to avoid such a problem, it is considered to add one insulating layer between the ITO layer in the icon portion and each of BM layers 182A, 182B. In this way, the conductive substance of each of BM layers 182A, 182B can be prevented from adversely affecting the ITO layer in the icon portion.

### CITATION LIST

### Patent Document

PTD 1: Japanese Patent Laying-Open No. 2009-295365

### SUMMARY OF INVENTION

### Technical Problem

However, the addition of one insulating layer between the paint film layer and the sensor layer requires a step of forming the insulating layer. This results in decreased production efficiency and increased manufacturing cost, disadvantageously.

The present invention has been made to solve the foregoing problem, and has an object to provide a touch panel and an electric device, by each of which manufacturing cost can be suppressed from being increased.

### Solution to Problem

In order to achieve the above-described object, according to an aspect of the present invention, a touch panel includes one transparent substrate. The transparent substrate includes: a main touch sensor region for detecting a touched two-dimensional location, the main touch sensor region including a two-dimensional touch sensor that detects the touched two-dimensional location; and at least one sub touch sensor region for detecting whether or not a touch has been done, the sub touch sensor region including a one-layer-structured touch sensor.

In the two-dimensional touch sensor, a main-side insulating layer is provided between an earlier-formed portion and a later-formed portion. According to the present invention, the touch panel can be configured such that the main-side insulating layer and a sub-side insulating layer can be formed in the same step and the later-formed portion and the one-layer structured touch sensor can be formed in the same step when a paint film layer having an icon drawn is provided in the sub touch sensor region and the sub-side insulating layer is provided between the paint film layer and the one-layer-structured touch sensor.

In this way, the insulating layer can be provided between the paint film layer and the one-layer-structured touch sensor and no additional step is required in providing the insulating layer. As a result, there can be provided a touch panel by which manufacturing cost can be suppressed from being increased.

Preferably, the one-layer-structured touch sensor is composed of a conductive material. The touch panel further includes a layer structure on the transparent substrate at the sub touch sensor region, the transparent substrate, a paint film layer, a sub-side insulating layer, and a layer of the one-layer-structured touch sensor being provided in the layer structure in this order. The paint film layer is a layer having an icon drawn using a paint material containing a conductive substance.

In the two-dimensional touch sensor, the main-side insulating layer is provided between the earlier-formed portion and the later-formed portion. According to the present invention, the touch panel can be configured such that the main-side insulating layer and the sub-side insulating layer can be formed in the same step and the later-formed portion and the one-layer-structured touch sensor can be formed in the same step because the paint film layer having the icon drawn is provided in the sub touch sensor region and the sub-side insulating layer is provided between the paint film layer and the one-layer-structured touch sensor.

In this way, the insulating layer can be provided between the paint film layer and the one-layer-structured touch sensor and no additional step is required in providing the insulating layer. As a result, the manufacturing cost can be suppressed from being increased while preventing an operation failure due to the paint film layer.

More preferably, the two-dimensional touch sensor includes a vertical sensor composed of the conductive material, a horizontal sensor composed of the conductive material, and a main-side insulating layer for providing insulation between the vertical sensor and the horizontal sensor. The sub-side insulating layer is in contact with the layer of the one-layer-structured touch sensor. The main-side insulating layer is in contact with a later-formed portion of portions included in the two-dimensional touch sensor, the later-formed portion being formed after the main-side insulating layer. The main-side insulating layer and the sub-side insulating layer are composed of the same material. The layer of the one-layer-structured touch sensor and the later-formed portion are composed of the same material.

In the two-dimensional touch sensor, the main-side insulating layer is provided between the earlier-formed portion and the later-formed portion. According to the present invention, the touch panel can be configured such that the main-side insulating layer and the sub-side insulating layer can be formed in the same step and the later-formed portion and the one-layer-structured touch sensor can be formed in the same step because the paint film layer having the icon drawn is provided in the sub touch sensor region, the sub-side insulating layer is provided between the paint film layer and the one-layer-structured touch sensor, the sub-side insulating layer is in contact with the layer of the one-layer-structured touch sensor, the main-side insulating layer is in contact with the later-formed portion, the main-side insulating layer and the sub-side insulating layer are composed of the same material, and the layer of the one-layer-structured touch sensor and the later-formed portion are composed of the same material.

In this way, the insulating layer can be provided between, the paint flint layer and the one-layer-structured touch sensor and no additional step is required in providing the insulating layer. As a result, the manufacturing cost can be suppressed from being increased while preventing an operation failure due to the paint film layer.

According to another aspect of the present invention, a touch panel includes one transparent substrate. The transparent substrate includes: a main touch sensor region for detecting a touched two-dimensional location; and at least one sub touch sensor region for detecting whether or not a touch has been done. The touch pastel further includes: a paint film layer that is disposed on and in contact with the transparent substrate at the sub touch sensor region and that has an icon drawn using a paint material containing a conductive substance; and an earlier-formed portion that is disposed on and in contact with the transparent substrate at the main touch sensor region. The earlier-formed portion is a portion of a two-dimensional touch sensor that defects the touched two-dimensional location and is composed of a conductive material.

The touch panel further includes: an insulating layer that is disposed on and in contact with the paint film layer in the sub touch sensor region, the earlier-formed portion in the main touch sensor region, and the transparent substrate at a portion not provided with the earlier-formed portion in the main touch sensor region; and a later-formed portion that is disposed on and in contact with the insulating layer in the main touch sensor region. The later-formed portion is a portion of the two-dimensional touch sensor and is composed of the conductive material. The touch panel further includes a one-layer-structured touch sensor, the one-layer-structured touch sensor being disposed on and in contact with the insulating layer in the sub touch sensor region and being composed of the conductive material.

According to the present invention, the touch panel can be configured such that the main-side insulating layer and the sub-side insulating layer can be formed in the same step and the later-formed portion and the one-layer-structured touch sensor can be formed in the same step because the paint film layer having the icon drawn is provided in the sub touch sensor region, the sub-side insulating layer is provided between the paint film layer and the one-layer-structured touch sensor, the sub-side insulating layer is in contact with the layer of the one-layer-structured touch sensor, the main-side insulating layer is in contact whit the later-formed portion, the main-side insulating layer and the sub-side insulating layer are composed of the same material, and the layer of the one-layer-structured touch sensor and the later-formed portion are composed of the same material.

In this way, the insulating layer can be provided between the paint film layer and the one-layer-structured touch sensor and no additional step is required in providing the insulating layer. As a result, there can be provided a touch panel by which the manufacturing cost can be suppressed from being increased while preventing an operation failure due to the paint film layer.

According to a still another aspect of the present invention, an electric device includes any one of the touch panels described above.

According to the present invention, there can be provided an electric device including a touch panel, by which the manufacturing cost can be suppressed from being increased while preventing an operation failure due to the paint film layer.

### BRIEF DESCRIPTION OF DRAWINGS

FIG. 1A is an upper view of an external appearance of a smartphone 1 in an embodiment of the present invention.

FIG. 1B is a front view of the external appearance of smartphone 1 in the embodiment of the present invention.

FIG. 1C is a lower view of the external appearance of smartphone 1 in the embodiment of the present invention.

FIG. 1D is a left side view of the external appearance of smartphone 1 in the embodiment of the present invention.

FIG. 1E is a right side view of the external appearance of smartphone 1 in the embodiment of the present invention.

FIG. 1F is a rear view of the external appearance of smartphone 1 in the embodiment of the present invention.

FIG. 2A is a front view of an external appearance of a touch panel unit in the present embodiment.

FIG. 2B is a rear view of the external appearance of the touch panel unit in the present embodiment.

FIG. 3 is a diagram for illustrating a difference between a conventional touch panel and the touch panel of the present embodiment.

FIG. 4 is a first diagram for illustrating emission of light to an icon portion prior to the present invention.

FIG. 5 is a second diagram for illustrating emission of light to the icon portion prior to the present invention.

FIG. 6 is a diagram for illustrating emission of light to an icon side touch sensor region in the present embodiment.

FIG. 7 is a cross sectional view for illustrating the emission of light to the icon side touch sensor regions in the present embodiment.

FIG. 8 is a diagram for illustrating emission of light to an icon side touch sensor region in a modification of the present embodiment.

FIG. 9A is a front view for illustrating a first layer structure of a touch panel prior to the present invention.

FIG. 9B is a cross sectional view taken along A-A for illustrating the first layer structure of the touch panel prior to the present invention.

FIG. 9C is a cross sectional view taken along B-B for illustrating the first layer structure of the touch panel prior to the present invention.

FIG. 10A is a front view for illustrating a second layer structure of a touch panel prior to the present invention.

FIG. 10B is a cross sectional view taken along C-C for illustrating the second layer structure of the touch panel prior to the present invention.

FIG. 10C is a cross sectional view taken along D-D for illustrating the second layer structure of the touch panel prior to the present invention.

FIG. 11A is a front view for illustrating the first layer structure of the touch panel in the present embodiment.

FIG. 11B is a cross sectional view taken along E-E for illustrating the first layer structure of the touch panel in the present embodiment.

FIG. 11C is a cross sectional view taken along F-F for illustrating the first layer structure of the touch panel hi the present embodiment.

FIG. 12A is a front view for illustrating the second layer structure of the touch panel in the present embodiment.

FIG. 12B is a cross sectional view taken along G-G for illustrating the second layer structure of the touch panel in the present embodiment.

FIG. 12C is a cross sectional view taken along H-H for illustrating the second layer structure of the touch panel in the present embodiment.

### DESCRIPTION OF EMBODIMENTS

The following describes an embodiment of the present invention in detail with reference to figures. It should be noted that the same or corresponding portions in the figures are given the same reference characters and are not described repeatedly.

In the below-described embodiment of the invention, it will be illustrated that the present invention is applied to a mobile terminal such as a smartphone 1 as an exemplary electric device. However, the electric device is not limited to such a mobile terminal as long as it has a touch panel, and may be a different device such as a personal computer (hereinafter, referred to as “PC”) and an AV (Audio Visual) device such as a BD (Blu-ray Disc) recorder. Further, the mobile terminal is not limited to smartphone 1 and may be a different device such as a mobile phone, a portable media player, and a tablet computer.

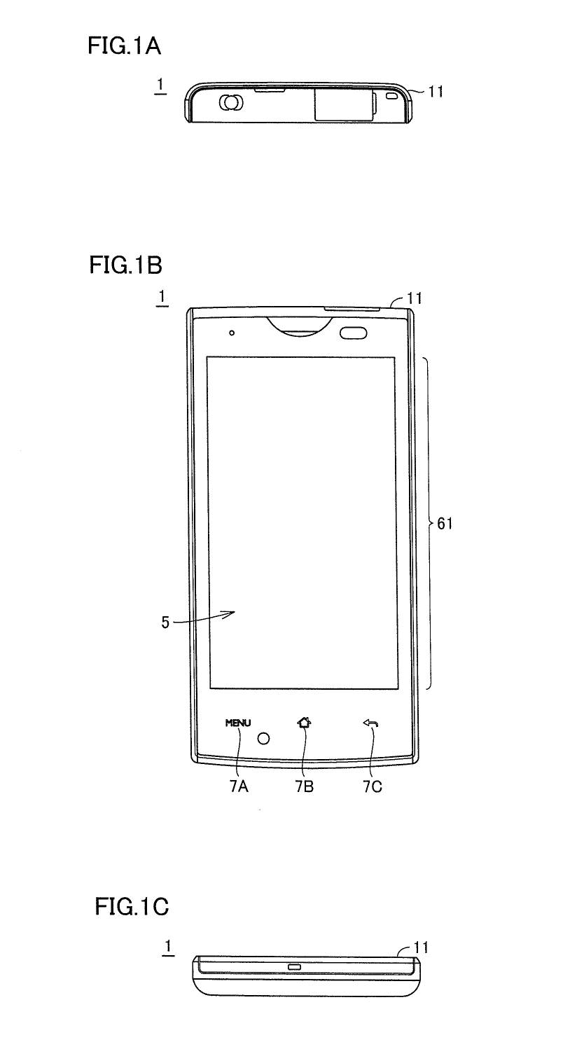

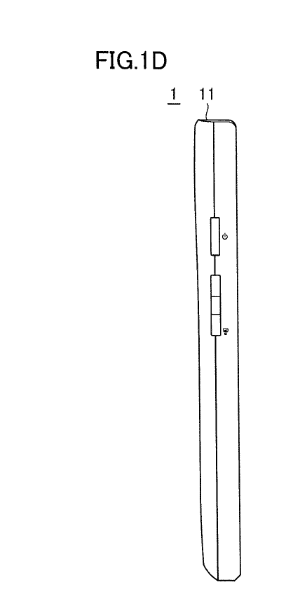

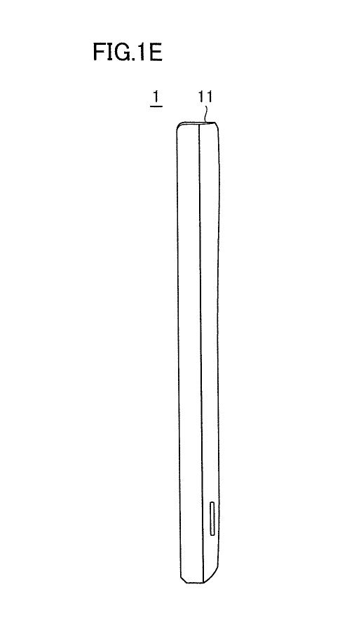

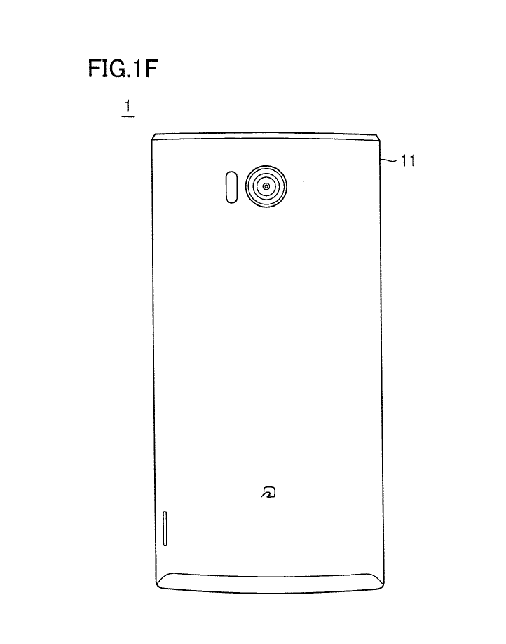

FIG. 1A to FIG. 1F are respectively an upper view, a front view, a lower view, a left side view, a right side view and a rear view of external appearance of smartphone 1 in the embodiment of the present invention. Referring to FIG. 1A to FIG. 1F, smartphone 1 includes a housing 11 and a display portion 5 as its main configurations.

At the front side of display portion 5, a touch panel is provided and a display portion side touch sensor region 61 is provided. Likewise, although not shown in the figures, icon portions 7A to 7C are also provided with icon portion side touch sensor regions for respective icon portions 7A to 7C.

In icon portion 7A, letters “MENU” are provided. This indicates that when a user touches icon portion 7A with a finger or the like, a display screen in display portion 5 makes transition to a menu screen.

In icon portion 7B, a drawing schematically representing a house is provided. This indicates that when the user touches icon portion 7B with a finger or the like, the display screen in display portion 5 makes transition to a home screen.

In icon portion 7C, an arrow indicating a return to a previous state is provided. This indicates that when the user touches icon portion 7C with a finger or the like, the display screen in display portion 5 returns to the immediately preceding screen.

It should be noted that icon, portions 7A to 7C may be provided with letters/characters or drawings of icons representing other functions to be performed. When each of icon portions 7A and 7C is operated, the function associated with the icon may be performed.

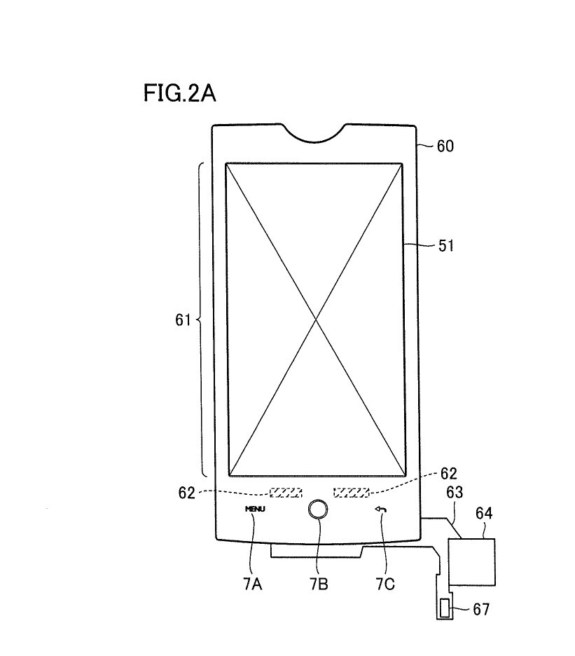

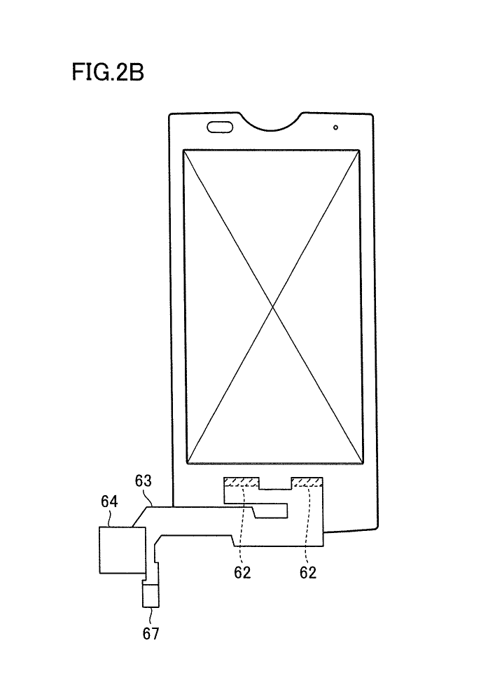

FIG. 2A and FIG. 2B are respectively a front view and a rear view of the external appearance of a touch panel unit in the present embodiment. Referring to FIG. 2A and FIG. 2B, FIG. 2A shows the front side of the touch panel unit whereas FIG. 2B shows the rear side of the touch panel unit. The touch panel unit includes a touch panel 60 and a flexible printed circuit (hereinafter, referred to as “FPC”) 63.

FPC 63 includes: an IC (Integrated Circuit) 64 that processes a signal output from touch panel 60; and a connection portion 67 for connection with other substrates or the like. FPC 63 is configured to process a signal output from touch panel 60 and transfer an output or processed signal.

Touch panel 60 and FPC 63 are connected to each other by ACF (Anisotropic Conductive Film) regions 62. ACF regions 62 herein are two separate AFC regions, but one ACF region 62 may be provided. The ACF, or anisotropic conductive film, is a film used to attach a component having a plurality of terminals to a component having respective connection portions for the terminals. By the ACF, a plurality of signal lines of touch panel 60 and a plurality of signal lines of FPC 63 are connected to one another with insulation being maintained.

In touch panel 60, a transmission region 51 is configured such that transparent electrodes are merely formed on a glass substrate therein as described below, so that an inner portion relative to transmission region 51 can be seen therethrough. Hence, through transmission region 51, the user can see a content displayed on display portion 5, which is provided inwardly of transmission region 51 in smart phone 1.

In the vicinity of transmission region 51 in touch panel 60, a BM (Black Mask) is provided through which an inner portion cannot be seen. Also, circuits and interconnections on touch panel 60 are not seen therein.

It should be noted that display portion side touch sensor region 61 is formed to have a size substantially as large as that of transmission region 51.

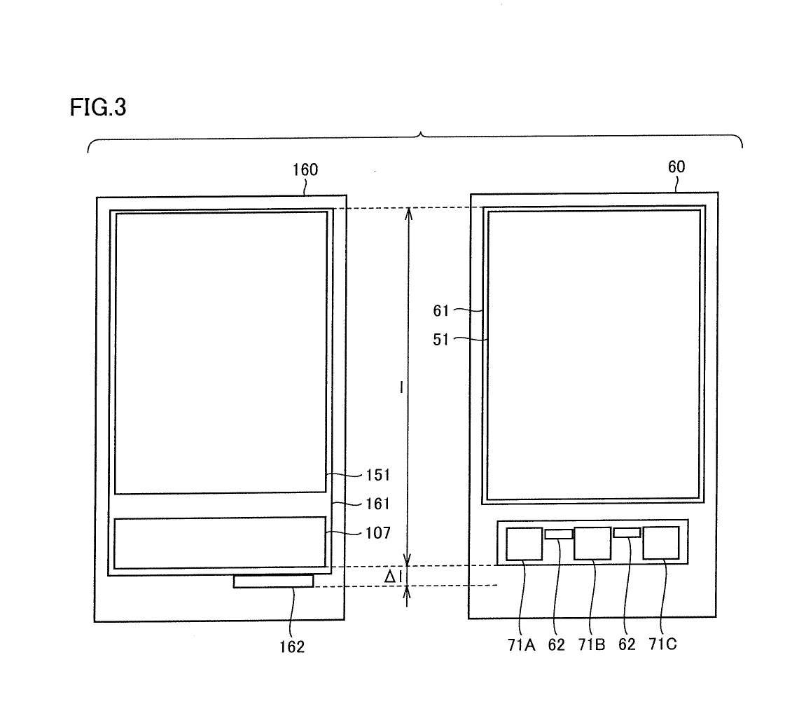

FIG. 3 is a diagrams for illustrating a difference between the conventional touch panel and the touch panel of the present embodiment. Referring to FIG. 3, the left portion of FIG. 3 represents the touch panel prior to the present invention. The right portion of FIG. 3 represents the touch panel of the present embodiment.

Conventionally, as shown in the left portion of FIG. 3, in order to detect a touch on icon portion 107 in touch panel 160, touch sensor region 161, which had been provided only for transmission region 151, in the display portion is extended to icon portion 107. Accordingly, ACF region 162 has to be provided outside touch sensor region 161 (here, at a lower right portion relative to icon portion 107).

In the present embodiment, as shown in the right portion of FIG. 3, in touch panel 60, display portion side touch sensor region 61 is provided only for transmission region 51. Moreover, icon side touch sensor regions 71A to 71C are provided for icon portions 7A to 7C.

Thus, such independent touch sensor regions are provided for icon portions 7A to 7C, with the result that there are space portions among display portion side touch sensor region 61 and the plurality of icon side touch sensor regions 71A to 71C.

Of these space portions, ACF regions 62 are provided in two space portions among three icon side touch sensor regions 71A to 71C in the present embodiment. In this way, assuming that a distance from the upper end of the touch sensor region to the lower end of the icon portion has a length 1 in each of the conventional technique and the present embodiment, the length of the functional portion of touch panel 60 in the present embodiment can be made shorter by a distance Δ1 than that in the one prior to the present invention. Distance Δ1 is from the lower end of icon portion 107 to the lower end of ACF region 162 in the touch panel prior to the present invention.

It should be noted that the locations of ACF regions 62 are not limited to the space portions among icon side touch sensor regions 71A to 71C, and ACF region(s) 62 may be provided in other space portion(s) as long as ACF region(s) 62 are provided in at least one of the space portions among display portion side touch sensor region 61 and the plurality of icon side touch sensor regions 71A to 71C. For example, an ACF region 62 may be provided in a space portion between display portion side touch sensor region 61 and one of icon side touch sensor regions 71A to 71C.

Further, in the case where the width of a minimum rectangle covering all the icon side touch sensors is smaller than the width of display portion side touch sensor region 61, for example, in the case where only one or two icon side touch sensor regions are provided, the length of the above-described functional portion of touch panel 60 can be made shorter advantageously even when an ACF region is provided in the range of a rectangle obtained by extending the rectangle of display portion side touch sensor region 61 to the lower end of the minimum rectangle covering all the icon side touch sensors.

If the space portions among display portion side touch sensor region 61 and the plurality of icon side touch sensor regions 71A to 71C are too narrow, incorrect detection may take place at a neighboring touch sensor region. Thus, according to the present embodiment, the space portions, which have to be provided to prevent such incorrect detection, can be effectively utilized. This is an additional effect of the present embodiment.

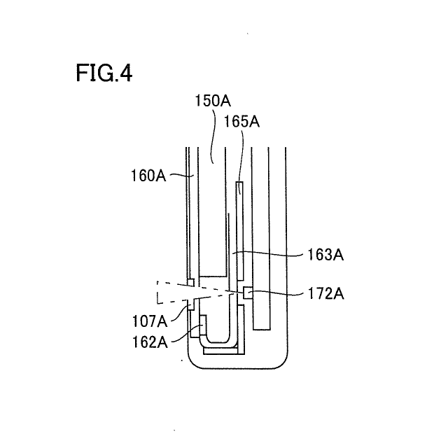

FIG. 4 is a first diagram for illustrating emission of light to the icon portion prior to the present invention. Referring to FIG. 4, when ACF region 162 is arranged as shown in the left portion of FIG. 3, FPC 163A connected to ACF region 162A of touch panel 161A is extended along a cabinet 165A to behind liquid crystal panel 150A.

In this case, beams of light emitted to icon portion 107A from an LED 172A disposed behind icon portion 107A are blocked by FPC 163A, disadvantageously.

FIG. 5 is a second diagram for illustrating emission of light to the icon portion prior to the present invention. Referring to FIG. 5, in order to overcome the disadvantage illustrated in FIG. 4, it is considered to position an LED 172B at such a location that light emitted from LED 172B to icon portion 107A is not blocked by FPC 163B or the like and employ an FPC 173B to supply electric power to LED 172B so as to avoid FPC 163B.

Alternatively, it is considered to provide a light guiding member 174B to guide the beams of light from LED 172B and position light guiding member 174B and LED 172B at locations not to interfere with FPC 163B.

In either case, the additional component such as FPC 173B or light guiding member 174B is required, resulting in increased manufacturing cost, disadvantageously.

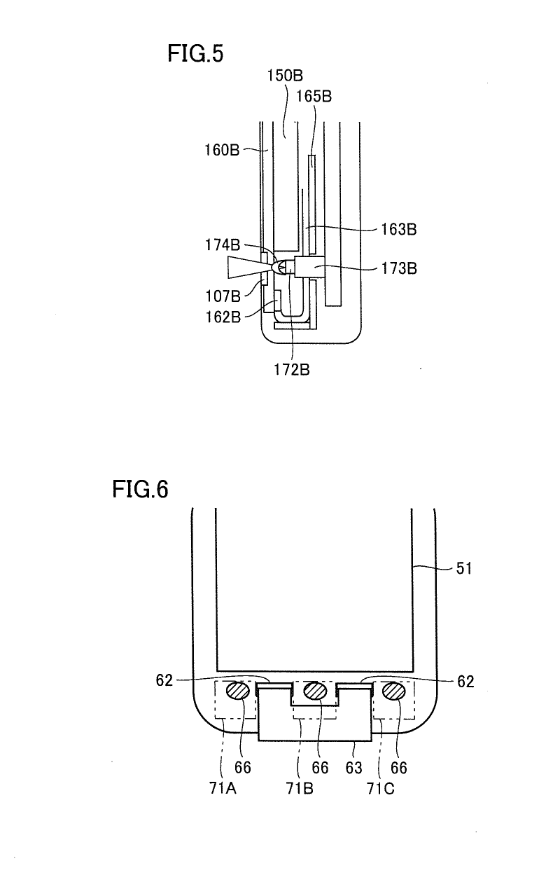

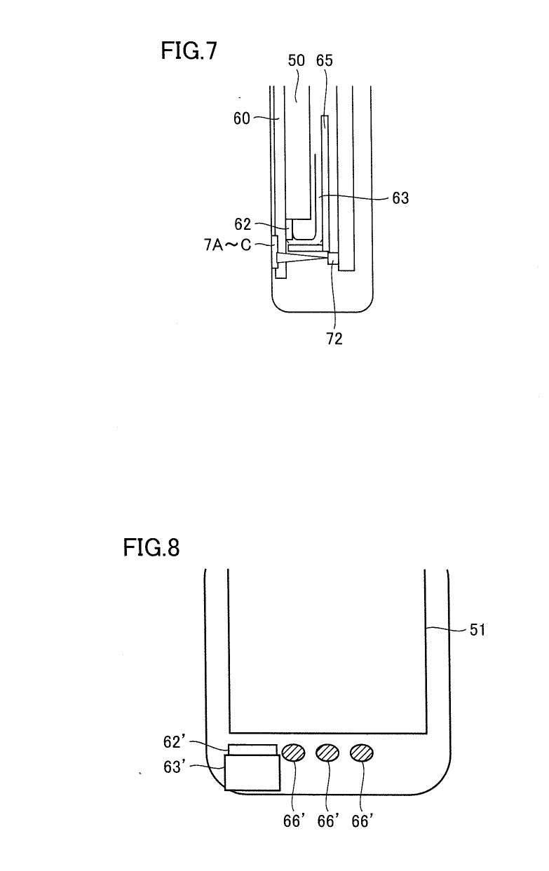

FIG. 6 is a diagram for illustrating emission of light to icon side touch sensor regions 71A to 71C in the present embodiment. FIG. 7 is a cross sectional view for illustrating the emission of light to the icon side touch sensor regions in the present embodiment. Referring to FIG. 6 and FIG. 7, in the present embodiment, as illustrated in the right portion of FIG. 3 and the like, ACF regions 62 are provided in the space portions among icon side touch sensor regions 71A and 71C, and FPC 63 has a shape such that FPC 63 can be disposed to avoid the beams of light from LED 72 to icon side touch sensor regions 71A to 71C when incorporated in smartphone 1, specifically, FPC 63 has a shape shown in FIG. 6 (in particular, FIG. 2B). Accordingly, without providing any particular configuration other than LED 72, illuminated ranges 66 are irradiated with light emitted by LED 72.

Further, FPC 63, which is connected to ACF regions 62, is extended in a direction substantially parallel to the connection surfaces thereof. Moreover, FPC 63 is formed to have a portion that extends from each of the connection portions with ACF regions 62 to each of first bent portions bent at substantially 90° or more and that is contained in the range of a columnar body having a cross section corresponding to a projection having the maximum area among parallel projections of touch panel 60.

Further, ACF regions 62 are formed in regions different from transmission region 51 as described above. The portion of FPC 63 that extends from the connection portion with ACF region 62 to the first bent portion bent at substantially 90° or more is disposed at a location not viewable from transmission region 51 when FPC 63 is incorporated in smartphone 1. Further, a portion subsequent to the bent portion can be extended to behind other devices, such as liquid crystal panel 50, disposed at the inner side relative to touch panel 60. In this way, FPC 63 is not viewable from transmission region 51.

Further, cabinet 65 is provided to position the portion from the connection portion to the bent portion such that the portion from the connection portion to the bent portion is contained in the range of the columnar body and is avoided from the beams of light from FED 72. Accordingly, the portion of FPC 63 from the connection portion with ACF region 62 to the first bent portion bent at substantially 90° or more can be more securely contained in the range of the columnar body having the cross section corresponding to the projection having the maximum area among the parallel projections of touch panel 60, and the light emitted from LED 72 to icon side touch sensor regions 71A to 71C can be more securely prevented front being blocked.

It should be noted that as long as FPC 63 is contained in housing 11 of smartphone 1, FPC 63 may not be extended from the ACF region in the direction substantially parallel to the connection surface and the first bent portion may be bent at an angle other than substantially 90° or more relative to the connection portion of FPC 63 with ACF region 62.

Further, in FIG. 7, icon side touch sensor regions 71A to 71C and LED 72 are actually positioned at such locations that the beams of light from LED 72 to icon side touch sensor regions 71A to 71C overlap with ACF regions 62 as shown in FIG. 6, but for simplicity of the figure and for convenience of explanation, the locations of icon side touch sensor regions 71A to 71C and LED 72 are illustrated to be displaced from each other in the downward direction of FIG. 7.

FIG. 8 is a diagram for illustrating emission of light to an icon side touch sensor region in a modification of the present embodiment. Referring to FIG. 8, when icon portions 7A to 7C are disposed such that icon portions 7A and 7C come closer to icon portion 7B disposed in the middle, an ACF region 62′ may be positioned as shown in the figure. In this case, as with FIG. 6, an FPC 63′ has a shape such that FPC 63′ can be disposed to avoid the beams of light from LED 72 to icon side touch sensor regions 71A to 71C when incorporated in smartphone 1.

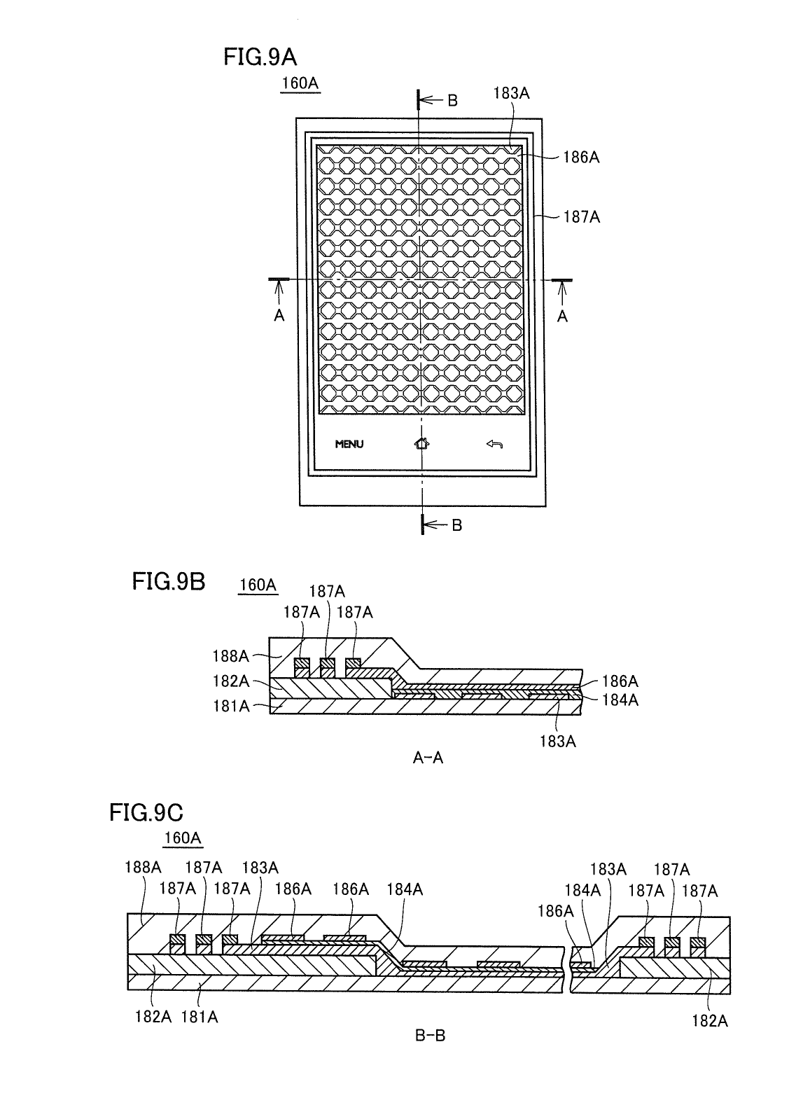

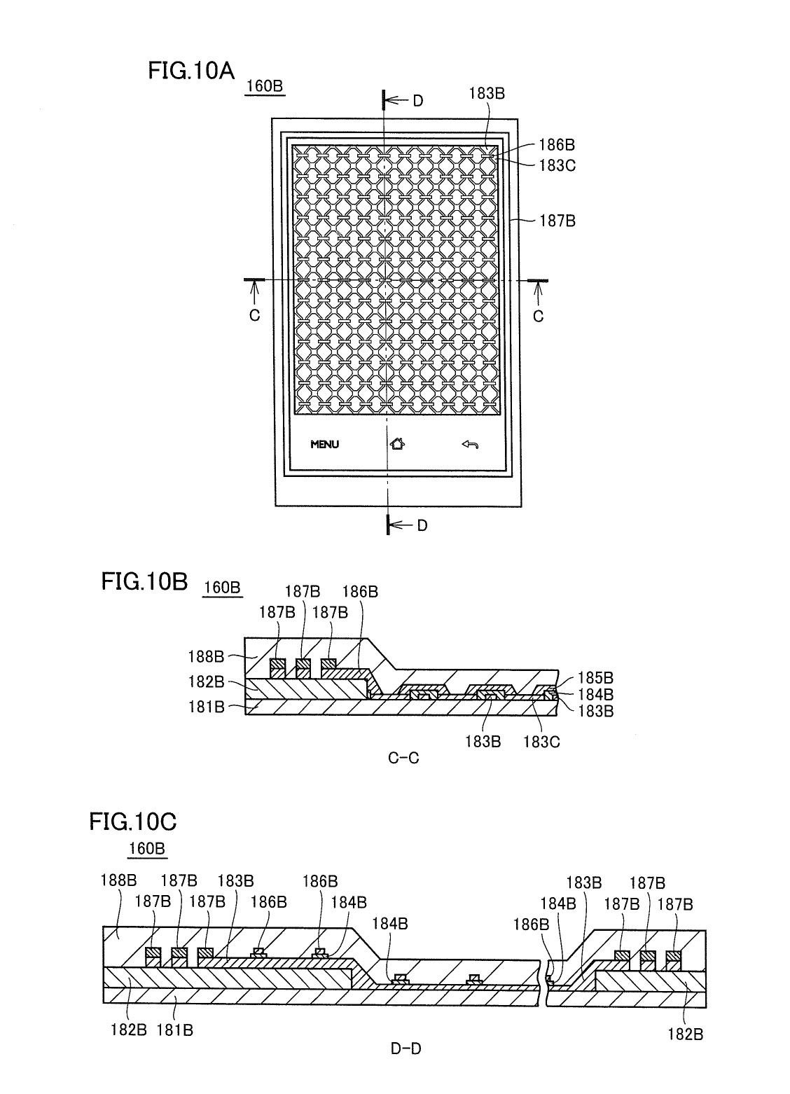

FIG. 9A is a front view for illustrating a first layer structure of a touch panel prior to the present invention. FIG. 9B is a cross sectional view taken along A-A. FIG. 9C is a cross sectional view taken along B-B. FIG. 10A is a front view for illustrating a second layer structure of a touch panel prior to the present invention. FIG. 10B is a cross sectional view taken along C-C. FIG. 10C is a cross sectional view taken along D-D. Referring to FIG. 9A to FIG. 9C and FIG. 10A to FIG. 10C, a mobile terminal such as a smartphone 1 is provided with a display portion and an icon portion disposed below the display portion and permitting a predetermined operation as shown in FIG. 9A and FIG. 10A so as to detect both a touch on the display portion and a touch on the icon portion using a detection region in each of touch panels 160A, 160B.

As shown in FIG. 9B, the display portion is configured such that a location touched by the user with a finger or the like in the display portion can be detected using an ITO (Indium Tin Oxide)-1 layer 183A and an ITO-2 layer 186A. ITO-1 layer 183A serves as a vertical sensor for touch panel 160A whereas ITO-2 layer 186A serves as a horizontal sensor for touch panel 160A. Likewise, as shown in FIG. 10B, the display portion is configured such that a location touched by the user with a finger or the like in the display portion can be detected using an ITO (Indium Tin Oxide)-1 layer 183B and an ITO-1 layer 183C. ITO-1 layer 183B serves as a vertical sensor for touch panel 160B whereas ITO-1 layer 183C serves as a horizontal sensor for touch panel 160B. Based on changes in capacitances of the vertical sensor and the horizontal sensor, the coordinates of the touched location are specified. Detection signals for these are output to outside touch panels 160A, 160B via a plurality of metal interconnections 187A, 187B, respectively.

As shown in FIG 9C, the icon portions are also configured such that it can be detected whether or not the user has touched the icon portions with a finger or the like using ITO-1 layer 183A serving as the vertical sensor for touch panel 160A and the ITO-2 layer serving as the horizontal sensor for touch panel 160A. Likewise, as shown in FIG. 10C, the icon portions are also configured such that it can be detected whether or not the user has touched the icon portions with a finger or the like using ITO-1 layer 183B serving as the vertical sensor for touch panel 160B and ITO-1 layer 182C serving as the horizontal sensor for touch panel 160B. Detection signals for these are also output to outside touch panels 160A, 160B via the plurality of metal interconnections 187A, 187B, respectively.

Here, in touch panels 160A, 160B, the icon marks in the icon portions are formed on glass substrates 181A, 181B using BM layers 182A, 182B, respectively. It should be noted that in FIG. 9A and FIG. 10A, no ITO layers are shown in the icon portions because the marks represented by BM layers 182A, 182B would have been otherwise unclear in the figures.

With such a configuration, a sensor can serve for both the display portion and the icon portion in each touch panel 160A, 160B and the icon marks can be included therein.

However, this configuration has the following problem. That is, BM layers 182A, 182B contain a conductive substance such as carbon and plural lines of ITO-1 layers 183A, 183B are directly in contact with BM layers 182A, 182B. This affects sensor performance in touch panels 160A, 160B.

In order to address problems such as occurrence of incorrect operation or non operation due to the electric conductivity of the carbon material powders contained in such a black ink, it is considered to use an insulative black ink as the marking ink as indicated in Japanese Patent Laying-Open No. 2009-295365. In this way, even when the black marking ink is used for the touch panel, the sensor performance in the touch panel can be less affected.

However, in this case, a degree of freedom is decreased in terms of the material of the ink and the color tone of the ink, disadvantageously. In the case where the touch sensors are formed on BM layers 182A, 182B formed on glass substrates 181A, 181B respectively, disconnection may take place due to level differences at BM layers 182A, 182B. Hence, each of BM layers 182A, 182B desirably has a thickness thinner than 10 μm to 20 μm, which is a thickness when solidly painting the ink. In such a case, if the degree of freedom in selecting an ink is low, it becomes more difficult to select an ink that exhibits a desired performance.

In order to avoid such a problem, it is considered to add one insulating layer between the ITO layer in the icon portion and each of BM layers 182A, 182B. In this way, the conductive substance of each of BM layers 182A, 182B can be prevented from adversely affecting the ITO layer in the icon portion.

However, the addition of one insulating layer between the paint film layer and the sensor layer requires a step of forming the insulating layer. This results in decreased production efficiency and increased manufacturing cost, disadvantageously.

It should be noted that in the present embodiment, the layer structure of the touch sensor region in FIG. 9A to FIG. 9C is referred to as “two-layer structure” and the layer structure of the touch sensor region in FIG. 10A to FIG. 10C is referred to as “bridge structure”.

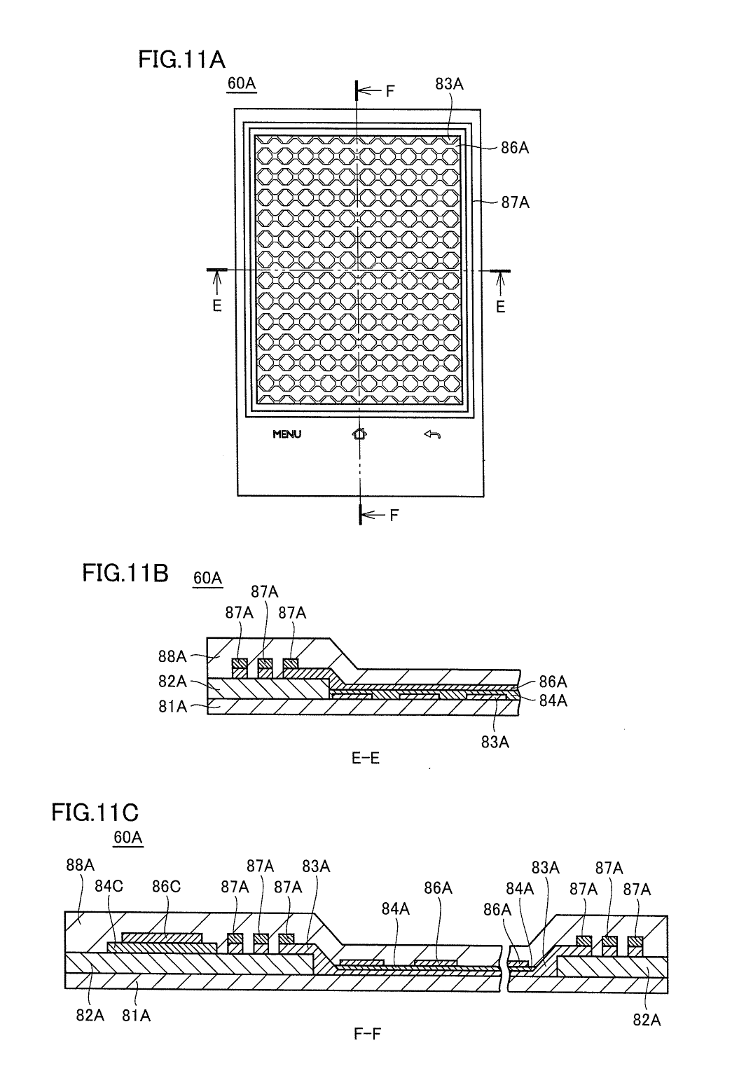

FIG. 11A is a front view for illustrating a first layer structure of touch panel 60A of the present embodiment. FIG. 11B is a cross sectional view taken along E-E. FIG. 11C is a cross sectional view taken along F-F. Referring to FIG. 11A to FIG. 11C, as with FIG. 9A to FIG. 9C, display portion side touch sensor region 61 in FIG. 11A to FIG. 11C has the “two-layer structure”. Touch panel 60A is formed on one glass substrate 81A. It should be noted that the present invention is not limited to glass substrate 81A and a different substrate may be employed as long as it is a transparent substrate.

Glass substrate 81A includes: display portion side touch sensor region 61 for detecting a touched two-dimensional location; and at least one icon side touch sensor region 71A to 71C for detecting whether or not a touch has been done.

Touch panel 60A includes: BM layer 82A that is disposed on and in contact with glass substrate 81A at icon side touch sensor regions 71A to 71C and that has icons drawn using a paint material having electric conductivity; and ITO-1 layer 83A that is disposed on and in contact with glass substrate 81A at display portion side touch sensor region 61 and that serves as an earlier-formed portion.

BM layer 82A is formed to have a very thin thickness of several put by means of deposition printing of an ink material containing carbon. ITO-1 layer 83A is a portion of the two-dimensional touch sensor for detecting a touched two-dimensional location, is formed prior to the formation of insulating layer 84A, and is composed of a conductive material such as ITO.

It should be noted that the two-dimensional touch sensor includes: ITO-1 layer 83A composed of ITO and serving as the vertical sensor; ITO-2 layer 86A composed of ITO and serving as the horizontal sensor; and insulating layer 84A for providing insulation between the vertical sensor and the horizontal sensor.

Touch panel 60A further includes: insulating layers 84A, 84C disposed on and in contact with BM layers 82A in icon side touch sensor regions 71A to 71C, ITO-1 layer 83A in display portion side touch sensor region 61, and glass substrate 81A at a portion not provided with ITO-1 layer 83A in display portion side touch sensor region 61; and ITO-2 layer 86A that is disposed on and in contact with insulating layer 84A in display portion side touch sensor region 61 and that serves as a later-formed portion.

ITO-2 layer 86A is a portion of the two-dimensional touch sensor, is formed after the formation of insulating layer 84A, and is composed of a conductive material such as ITO.

Touch panel 60A further includes ITO-2 layer 86C that is disposed on and in contact with insulating layer 84C in icon side touch sensor regions 71A to 71C, that is composed of a conductive material such as ITO, and that is included in a one-layer-structured touch sensor.

With such a configuration, BM layers 82A having the icons drawn are provided in icon side touch sensor regions 71A to 71C, and insulating layer 84C in icon side touch sensor regions 71A to 71C is provided between BM layer 82A and ITO-2 layer 86C included in the one-layer-structured touch sensor.

Insulating layer 84C in icon side touch sensor regions 71A to 71C is in contact with ITO-2 layer 86C included in the one-layer-structured touch sensor. Insulating layer 84A in display portion side touch sensor region 61 is in contact with ITO-2 layer 86A serving as the later-formed portion. Insulating layers 84A, 84C are composed of the same material. ITO-2 layer 86C included in the one-layer-structured touch sensor and ITO-2 layer 86A serving as the later-formed portion are composed of the same material.

Accordingly, insulating layers 84A, 84C can be formed in the same step. Moreover, ITO-2 layer 86A serving as the later-formed portion and ITO-2 layer 86C included in the one-layer-structured touch sensor can be formed in the same step.

In this way, insulating layer 84C can be provided between BM layer 82A and ITO-2 layer 86C included in the one-layer-structured touch sensor and no additional step is required in providing insulating layer 84C. As a result, the manufacturing cost can be suppressed from being increased while preventing an operation failure due to BM layer 82A.

Moreover, metal interconnection 87A is provided to connect to each one of ITO-1 layer 83A serving as the vertical sensor and ITO-2 layer 86A serving as the horizontal sensor. Metal interconnection 87A is provided in a region different from transmission region 51 and having BM layer 82A formed thereon. Accordingly, metal interconnection 87A can be less likely to be seen and recognized from outside.

Further, insulating layer 88A is provided to cover the uppermost portion of each of the above-described layers. Accordingly, each layer having electric conductivity is insulated from outside touch panel 60A.

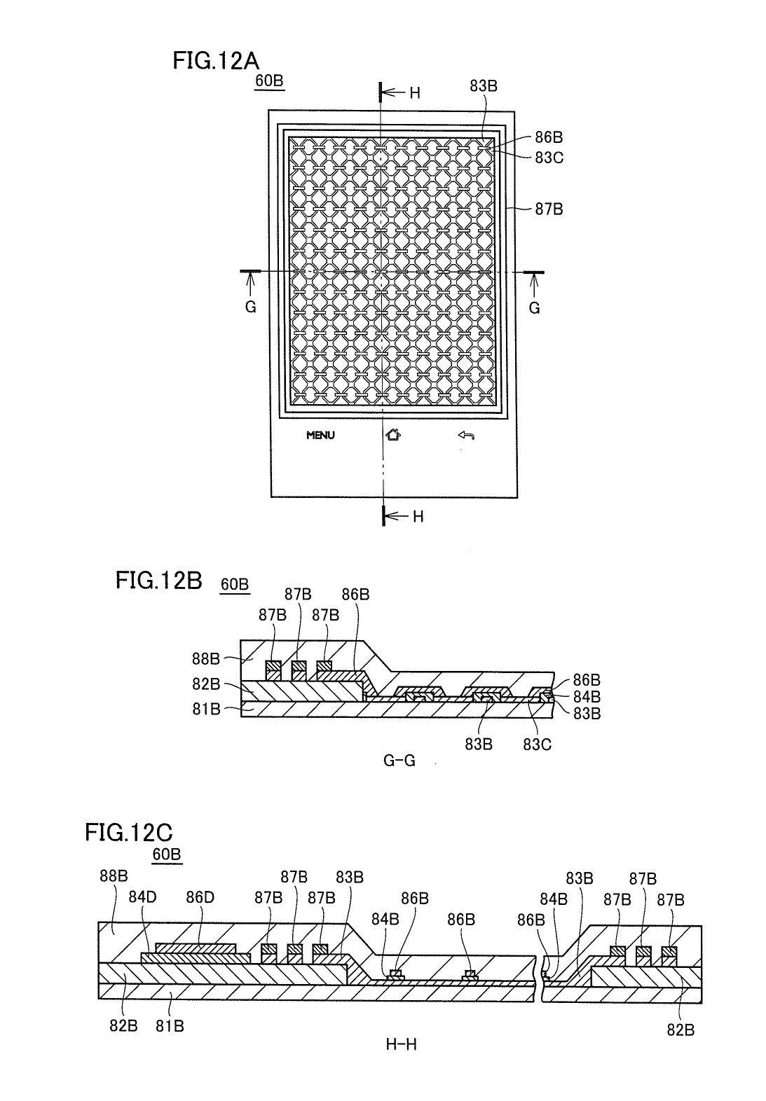

FIG. 12A is a front view for illustrating a second layer structure of touch panel 60B of the present embodiment. FIG. 12B is a cross sectional view taken along G-G. FIG. 12C is a cross sectional view taken along H-H. Referring to FIG. 12A to FIG. 12C, as with FIG. 10A to FIG. 10C, display portion side touch sensor region 61 in FIG. 12A to FIG. 12C has the “bridge structure”. Touch panel 60B is formed on one glass substrate 81B. It should be noted that the present invention is not limited to glass substrate 81B and a different substrate may be employed as long as it is a transparent substrate.

Glass substrate 81B includes: display portion side touch sensor region 61 for detecting a touched two-dimensional location; and at least one icon side touch sensor region 71A to 71C for detecting whether or not a touch has been done.

Touch panel 60B includes: BM layer 82B that is disposed on and in contact with glass substrate 81B at icon side touch sensor regions 71A to 71C and that has icons drawn using a paint material having electric conductivity; and ITO1 layers 83B, 83C that are disposed on and in contact with glass substrate 81B at display portion side touch sensor region 61 and that serve as the earlier-formed portion.

BM layer 82B is formed to have a very thin thickness of several μm by means of deposition printing of an ink material containing carbon. Each of ITO-1 layers 83B, 83C is a portion of the two-dimensional touch sensor for detecting a touched two-dimensional location, is formed prior to the formation of insulating layer 84B, and is composed of a conductive material such as ITO.

It should be noted that the two-dimensional touch sensor includes: ITO-1 layer 83B composed of ITO and serving as the vertical sensor; ITO-1 layer 83C and ITO-2 layer 86B each composed of ITO and serving as the horizontal sensor; and insulating layer 84B for providing insulation between the vertical sensor and the horizontal sensor.

Touch panel 60B further includes: insulating layers 84B, 84D disposed on and in contact with BM layers 82B in icon side touch sensor regions 71A to 71C, ITO-1 layers 83B, 83C in display portion side touch sensor region 61, and glass substrate 81B at a portion not provided with ITO-1 layers 83B, 83C in display portion side touch sensor region 61; and ITO-2 layer 86B that is disposed on and in contact with insulating layer 84B in display portion side touch sensor region 61 and that serves as a later-formed portion.

ITO-2 layer 86B is a portion of the two-dimensional touch sensor, is formed after the formation of insulating layer 84B, and is composed of a conductive material such as ITO.

Touch panel 60B further includes ITO-2 layer 86D that is disposed on and in contact with insulating layer 84D in icon side touch sensor regions 71A to 71C, that is composed of a conductive material such as ITO, and that is included in the one-layer-structured touch sensor.

With such a configuration, BM layers 82B having the icons drawn are provided in icon side touch sensor regions 71A to 71C, and insulating layer 84C in icon side touch sensor regions 71A to 71C is provided between BM layer 82B and ITO-2 layer 86D included in the one-layer-structured touch sensor.

Insulating layer 84D in each of icon side touch sensor regions 71A to 71C is in contact with ITO-2 layer 86D included in the one-layer-structured touch sensor. Insulating layer 84B in display portion side touch sensor region 61 is in contact with ITO-2 layer 86B serving as the later-formed portion. Insulating layers 84B, 84D are composed of the same material. ITO-2 layer 860 included in the one-layer-structured touch sensor and ITO-2 layer 86B serving as the later-formed portion are composed of the same material.

Accordingly, insulating layers 84B, 84D can be formed in the same step. Moreover, ITO-2 layer 86B serving as the later-formed portion and ITO-2 layer 86D included in the one-layer-structured touch sensor can be formed in the same step.

In this way, insulating layer 84D can be provided between BM layer 82B and ITO-2 layer 860 included in the one-layer-structured touch sensor and no additional step is required in providing insulating layer 84D. As a result, the manufacturing cost can be suppressed from being increased while preventing an operation failure due to BM layer 82B.

Moreover, metal interconnection 87B is provided to connect to each one of ITO-1 layer 83B serving as the vertical sensor and ITO-1 layer 83C and ITO-2 layer 86B both serving as the horizontal sensor. Metal interconnection 87B is provided in a region different from transmission region 51 and having BM layer 82B formed thereon. Accordingly, metal interconnection 87B can be less likely to be seen and recognized from outside.

Further, insulating layer 88B is formed to cover the uppermost portion of each of the above-described layers. Accordingly, each layer having electric conductivity is insulated from outside touch panel 60B.

The following describes effects of the embodiment described above.

(1) Conventionally, as indicated in Japanese Patent Laying-Open No. 2002-333640, a signal output portion is disposed at an end portion of a device, such as a touch panel and a liquid crystal panel, in which transparent electrodes are arranged in the form of a matrix.

However, such a device requires a region for containing a FPC flexible printed circuit (hereinafter referred to as “FPC”), which is extended from the signal output portion, in the housing of a mobile terminal (such as a mobile phone, a smartphone, a portable media player, or a tablet computer) including the device. Accordingly, the housing needs to have a surface wider than the display surface of the liquid crystal panel and the operation surface of the touch panel.

Because the present embodiment provides the following configuration, it can be compactly incorporated in an electric device.

(1-1) A touch panel (for example, touch panel 60) includes: a plurality of touch sensor regions (for example, display portion side touch sensor region 61 and icon side touch sensor regions 71A to 71C), each of which detects a touch and outputs a signal indicating that the detection has been done; and one or more signal output regions (for example, ACF region(s) 62) that collectively outputs the signals, which are sent from the plurality of touch sensor regions, to outside. The signal output region is provided in any one of space portions among the plurality of touch sensor regions.

In this way, the connection portion of a component, such as an FPC (for example, FPC 63), connected to the signal output region can be contained in the range of a columnar body having a cross section corresponding to a rectangular region containing the plurality of touch sensor regions therein. As a result, it can be compactly incorporated in an electric device (for example, smartphone 1).

(1-2) Further, an FPC, which transfers or processes a signal output from the touch panel, can be connected to the signal output region, and the FPC is extended in a direction substantially parallel to the connection surface. A portion of the FPC from a connection portion with the signal output region to a first bent portion bent at substantially 90° or more can be contained in the range of a columnar body having a cross section corresponding to a projection having the maximum area among parallel projections of the touch panel.

Accordingly, the portion of the FPC from the connection portion with the signal output region to the first bent portion bent at substantially 90° or more can be contained in the range of the columnar body having the cross section corresponding to the projection having the maximum area among the parallel projections of the touch panel. As a result, the touch panel can be incorporated in the electric device more compactly.

(1-3) Further, at least one of the plurality of touch sensor regions is provided in a transmission region (for example, transmission region 51) formed to permit passage of light therethrough, the rest being provided in a region (for example, icon portions 7A to 7C) having a drawn icon such that a touch on the icon is able to be detected.

Accordingly, the liquid crystal panel (for example, liquid crystal panel 50) is provided in the transmission region of the touch panel, whereby a touched location on the display screen can be detected and a function associated with the icon can be performed.

(1-4) A touch panel unit includes a touch panel (touch panel 60) and an FPC (for example, FPC 63) that transfers or processes the signal output from the touch panel. The touch panel includes: a plurality of touch sensor regions (for example, display portion side touch sensor region 61 and icon side touch sensor regions 71A to 71C), each of which detects a touch and outputs a signal indicating that the detection has been done; and one or more signal output regions (for example, ACF region(s) 62) that collectively outputs the signals, which are sent from the plurality of touch sensor regions, to outside.

The signal output region is provided in any one of space portions among the plurality of touch sensor regions. The FPC, connected to the signal output region, is extended in a direction substantially parallel to the connection surface thereof. A portion of the FPC front a connection portion with the signal output region to a first bent portion bent at substantially 90° or more can be contained in the range of a columnar body having a cross section corresponding to a projection having the maximum area among parallel projections of the touch panel.

Accordingly, the portion of the flexible printed circuit from the connection portion with the signal output region to the first bent portion bent at substantially 90° or more can be contained in the range of the columnar body having the cross section corresponding to the projection having the maximum area among the parallel projections of the much panel. As a result, there can be provided a touch panel unit which allows the touch panel to be compactly incorporated in an electric device.

(1-5) Further, at least one of the plurality of touch sensor regions is provided in a transmission region (for example, transmission region 51) formed to permit passage of light therethrough, the rest being provided in a region (for example, icon portions 7A to 7C) having a drawn icon such that a touch on the icon is able to be detected.

Accordingly, the liquid crystal panel (for example, liquid crystal panel 50) is provided in the transmission region of the touch panel, whereby a touched location on the display screen can be detected and a function associated with the icon can be performed.

(1-6) Further, the signal output region is provided at a region (for example, region provided with BM layers 82A, 82B) different from the transmission region (for example, transmission region 51) formed to permit passage of light therethrough. The portion from the connection portion to the bent portion is able to be disposed at a location not viewable from the transmission region.

Accordingly, the portion from the connection portion to the bent portion can be disposed such that it is not viewable from the transmission region. A portion subsequent to the bent portion is extended to behind the liquid crystal panel (for example, liquid crystal panel 50), other substrates, and the like disposed at an inner portion relative to the touch panel, whereby the FPC can be unseen from the transmission region. As a result, the touch panel unit can be incorporated in an electric device (for example, smartphone 1) such that the FPC can be unseen from the transmission region.

(1-7) An electric device (for example, smartphone 1) includes one of the touch panels or the touch panel units described above.

Accordingly, there can be provided an electric device including the touch panels and the touch panel units, which can be compactly incorporated in the electric device.

(2) Conventionally, as indicated in Japanese Patent Laying-Open No. 2002-333640, a signal output portion is provided at an end portion of a device, such as a touch panel and a liquid crystal panel, in which transparent electrodes are arranged in the form of a matrix. In such a device, when the panel is irradiated with light emitted from behind, the signal output portion can be readily configured not to interfere with the beams of light emitted therefrom.

Meanwhile, as indicated in Japanese Patent Laying-Open No. 2007-234584, there is a technique of emitting light to a touch sensor using a light guiding plate. In such a technique, the beams of light emitted can be prevented from being interfered by other objects.

However, such a device in Japanese Patent Laying-Open No. 2002-333640 requires a region for containing a flexible printed circuit (hereinafter referred to as “FPC”), which is extended front the signal output portion, in the housing of a mobile terminal (such as a mobile phone, a smartphone, a portable media player, or a tablet computer) including the device. Accordingly, the housing needs to have a surface wider than the display surface of the liquid crystal panel and the operation surface of the touch panel.

In addition, the technique of Japanese Patent Laying-Open No. 2007-234584 requires the light guiding plate in addition to the light source such as an LED (light Emitting Diode), with the result that component cost for the light guiding plate and manufacturing cost in incorporating the light guiding plate are required, disadvantageously.

Because the embodiment provides the following configuration, it can be compactly incorporated in an electric device while attaining emission of light with the manufacturing cost being suppressed from being increased.

(2-1) A touch panel unit includes a touch panel (for example, touch panel 60) and an FPC (for example, FPC 63) that transfers or processes a signal output from the touch panel. The touch panel includes: a plurality of touch sensor regions (for example, display portion side touch sensor region 61 and icon side touch sensor regions 71A to 71C), each of which detects a touch and outputs a signal indicating that the detection has been done; and one or more signal output regions (for example, ACF region(s) 62) that collectively outputs the signals, which are sent from the plurality of touch sensor regions, to outside.

The signal output region is provided in any one of space portions among the plurality of touch sensor regions. At least one of the plurality of touch sensor regions is provided in an icon region (for example, icon portions 7A to 7C) such that a touch on an icon can be detected, and the icon region is a region having a drawn icon through a portion of which light is permitted to pass.

The touch panel unit further includes a lighting device (for example, LED 72) that irradiates the icon region with light from behind. The FPC, connected to the signal output region, is extended in a direction substantially parallel to the connection surface thereof. A portion of the FPC from a connection portion with the signal output region to a first bent portion bent at substantially 90° or more can be contained in the range of a columnar body having a cross section corresponding to a projection having the maximum area among parallel projections of the touch panel, and can be disposed to avoid the beams of light from the lighting device to the icon region.

Accordingly, the portion of the FPC from the connection portion with the signal output region to the first bent portion bent at substantially 90° or more can be contained in the range of the columnar body having the cross section corresponding to the projection having the maximum area among the parallel projections of the touch panel. Further, the light emitted from the lighting device to the icon region is not blocked, whereby there is no need to provide a configuration other than the lighting device. As a result, the touch panel unit can be compactly incorporated in the electric device, and emission of light can be attained while suppressing increase of the manufacturing cost.

(2-2) Further, the signal output region is provided in a region different front a transmission region (for example, transmission region 51) formed to permit passage of light therethrough. The portion from the connection portion to the bent portion can be disposed at a location not viewable from the transmission region.

Accordingly, the portion from the connection portion, to the bent portion can be disposed such that it is not viewable from the transmission region. A portion subsequent to the bent portion is extended to behind the liquid crystal panel (for example, liquid crystal panel 50), other substrates, and the like disposed at an inner portion relative to the touch panel, whereby the FPC can be unseen from the transmission region. As a result, the touch panel unit can be incorporated in an electric device such that the FPC can be unseen from the transmission region.

(2-3) An electric device (for example, a smartphone) includes one of the touch panel units described above.

Accordingly, there can be provided an electric device including a touch panel unit that can be compactly incorporated in the electric device and allows for emission of light while suppressing increase of the manufacturing cost.

(2-4) The electric device includes a restraining member (for example, cabinet 65) by which the portion from the connection portion to the bent portion is contained in the range of the columnar body and is disposed to avoid the beams of light.

According to the present invention, the portion of the FPC from the connection portion with the signal output region to the first bent portion bent at substantially 90° or more can be more securely contained in the range of the columnar body having the cross section corresponding to the projection having the maximum area among the parallel projections of the touch panel, and the light emitted from the lighting device to the icon region can be more securely prevented from being blocked.

(3) Referring to FIG. 9A to FIG. 9C and FIG. 10A to FIG. 10C, a mobile terminal such as a smartphone is provided with a display portion and an icon portion disposed below the display portion and permitting a predetermined operation as shown in FIG. 9A and FIG. 10A so as to detect both a touch on the display portion and a touch on the icon portion using a detection region in each of touch panels 100A, 160B.

As shown in FIG. 9B, the display portion is configured such that a location touched by the user with a finger or the like in the display portion can be detected using an ITO-1 layer 183A and an ITO-2 layer 186A. ITO-1 layer 183A serves as a vertical sensor for touch panel 160A whereas ITO-2 layer 186A serves as a horizontal sensor for touch panel 160A. Likewise, as shown in FIG. 10B, the display portion is configured such that a location touched by the user with a finger or the like in the display portion can be detected using an ITO-1 layer 183B and an ITO-1 layer 183C. ITO-1 layer 183B serves as a vertical sensor for touch panel 160B whereas ITO-1 layer 183C serves as a horizontal sensor for touch panel 160B. Detection signals for these are output to outside touch panels 160A, 160B via a plurality of metal interconnections 187A, 187B, respectively.

As shown in FIG. 9C, the icon portions are also configured such that it can be detected whether or not the user has touched the icon portions with a finger or the like using ITO-1 layer 183A serving as the vertical sensor for touch panel 160A and the ITO-2 layer serving as the horizontal sensor for touch panel 160A. As shown in FIG. 10C, the icon portions are also configured such that it can be detected whether or not the user has touched the icon portions with a finger or the like using ITO-1 layer 183B serving as the vertical sensor for touch panel 160B and ITO-1 layer 183C serving as the horizontal sensor for touch panel 160B. Detection signals for these are also output to outside touch panels 160A, 160B via a plurality of metal interconnections 187A, 187B, respectively.

Here, in touch panels 160A, 160B, icon marks in the icon portions are formed on glass substrates 181A, 181B using BM layers 182A, 182B, respectively. It should be noted that in FIG. 9A and FIG. 10A, no ITO layers are shown in the icon portions because the marks represented by BM layers 182A, 182B would have been otherwise unclear in the figures.

With such a configuration, a sensor can serve for both the display portion and the icon portion in each touch panel 160A, 160B and the icon marks can be included therein.

However, this configuration has the following problem. That is, BM layers 182A, 182B contain a conductive substance such as carbon and plural lines of ITO-1 layers 183A, 183B are directly in contact with BM layers 182A, 182B. This affects sensor performance in touch panels 160A, 160B.

In order to address problems such as occurrence of incorrect operation or non operation due to the electric conductivity of the carbon material powders contained in such a black ink, it is considered to use an insulative black ink as the marking ink as indicated in Japanese Patent Laying-Open No. 2009-205365. In this way, even when the black marking ink is used for the touch panel, the sensor performance in the touch panel can be less affected.

However, in this case, a decree of freedom is decreased in terms of the material of the ink and the color tone of the ink, disadvantageous. In the case where the touch sensors are formed on BM layers 182A, 182B formed on glass substrates 181A, 181B respectively, disconnection may take place due to level differences at BM layers 182A, 182B. Hence, each of BM layers 182A, 182B desirably has a thickness thinner than 10 μm to 20 μm, which is a thickness when solidly painting the ink. In such a case, if the degree of freedom in selecting an ink is low, it becomes more difficult to select an ink that exhibits a desired performance.

In order to avoid such a problem, it is considered to add one insulating layer between the ITO layer in the icon portion and each of BM layers 182A, 182B. In this way, the conductive substance of each of BM layers 182A, 182B can be prevented from adversely affecting the ITO layer in the icon portion.

However, the addition of one insulating layer between the paint film layer and the sensor layer requires a step of forming the insulating layer. This results in decreased production efficiency and increased manufacturing cost, disadvantageously.

Because the present embodiment provides the following configuration, the manufacturing cost can be suppressed front being increased while preventing an operation failure due to the paint film layer.

(3-1) A touch panel (for example, touch panel 60) includes one transparent substrate (for example, glass substrate 81A, 81B). The transparent substrate includes: a main touch sensor region (for example, display portion side touch sensor region 61) for defecting a touched two-dimensional location, the main touch sensor region including a two-dimensional touch sensor that detects the touched two-dimensional location; and at least one sub touch sensor region (for example, icon side touch sensor regions 71A to 71C) for detecting whether or not a touch has been done, the sub touch sensor region including a one-layer-structured touch sensor.

In the two-dimensional touch sensor, a main-side insulating layer (for example, insulating layer 84A, 84B) is provided between an earlier-formed portion and a later-formed portion. Accordingly, the touch panel can be configured such that the main-side insulating layer and a sub-side insulating layer (for example, insulating layer 84C, 84D) can be formed in the same step and the later-formed portion and the one-layer-structured touch sensor can be formed in the same step when a paint film layer (for example, BM 82A, 82B) having an icon drawn is provided in the sub touch sensor region and the sub-side insulating layer is provided between the paint film layer and the one-layer-structured touch sensor.

In this way, the insulating layer can be provided between the paint film layer and the one-layer-structured touch sensor and no additional step is required in providing the insulating layer. As a result, the manufacturing cost can be suppressed from being increased while preventing an operation failure due to the paint film layer.

(3-2) Further, the one-layer-structured touch sensor is composed of a conductive material (for example, ITO). The touch panel further includes a layer structure on the transparent substrate at the sub touch sensor region, the transparent substrate, a paint film layer, a sub-side insulating layer, and a layer (for example, ITO-2 layer 86C, 86D) of the one-layer-structured touch sensor being provided in the layer structure in this order. The paint film layer is a layer having an icon drawn using a paint material containing a conductive substance.

In the two-dimensional touch sensor, the main-side insulating layer is provided between the earlier-formed portion and the later-formed portion. Accordingly, the touch panel can be configured such that the main-side insulating layer and the sub-side insulating layer can be formed in the same step and the later-formed portion and the one-layer-structured touch sensor can be formed in the same step because the paint film layer having the icon drawn is provided in the sub touch sensor region and a sub-side insulating layer is provided between the paint film layer and the one-layer-structured touch sensor.

In this way, the insulating layer can be provided between the paint film layer and the one-layer-structured touch sensor and no additional step is required in providing the insulating layer. As a result, the manufacturing cost can be suppressed from being increased while preventing an operation failure due to the paint film layer.

(3-3) Further, the two-dimensional touch sensor includes a vertical sensor composed of the conductive material (for example, ITO), a horizontal sensor composed of the conductive material (for example, ITO), and a main-side insulating layer for providing insulation between the vertical sensor and the horizontal sensor. The sub-side insulating layer is in contact with the layer of the one-layer-structured touch sensor. The main-side insulating layer is in contact with a later-formed portion (for example, ITO-2 layer 86A serving as the second layer in the two-layer structure and ITO-2 layer 86B serving as abridge in the bridge structure) of portions included in the two-dimensional touch sensor, the later-formed portion being formed after the main-side insulating layer. The main-side insulating layer and the sub-side insulating layer are composed of the same material. The layer of the one-layer-structured touch sensor and the later-formed portion are composed of the same material.

In the two-dimensional touch sensor, the main-side insulating layer is provided between the earlier-formed portion (for example, ITO-1 layer 83A serving as the vertical sensor in the two-layer structure as well as ITO-1 layer 83B serving as the vertical sensor and ITO-1 layer 83C serving as a portion of the horizontal sensor in the bridge structure) and the later-formed portion. Accordingly, the touch panel can be configured such that the main-side insulating layer and the sub-side insulating layer can be formed in the same step and the later-formed portion and the one-layer-structured touch sensor can be formed in the same step because the paint film layer having the icon drawn is provided in the sub touch sensor region, the sub-side insulating layer is provided between the paint film layer and the one-layer-structured touch sensor, the sub-side insulating layer is in contact with the layer of the one-layer-structured touch sensor, the main-side insulating layer is in contact with the later-formed portion, the main-side insulating layer and the sub-side insulating layer are composed of the same material, and the layer of the one-layer-structured touch sensor and the later-formed portion are composed of the same material.

In this way, the insulating layer can be provided between the paint film layer and the one-layer-structured touch sensor and no additional step is required in providing the insulating layer. As a result, the manufacturing cost can be suppressed from being increased while preventing an operation failure due to the paint film layer.

(3-4) A touch panel (for example, touch panel 60) includes one transparent substrate (for example, glass substrate 81A, 81B). The transparent substrate includes a main touch sensor region (for example, display portion side touch sensor region 61) for defecting a touched two-dimensional location and at least one sub touch sensor region (for example, icon side touch sensor region 71A to 71C) for detecting whether or not a touch has been done. The touch panel further includes: a paint film layer (for example, BM 82A, 82B) that is disposed on and in contact with the transparent substrate at the sub touch sensor region and that has an icon drawn using a paint material containing a conductive substance; and an earlier-formed portion (for example, ITO-1 layer 83A serving as the vertical sensor in the two-layer structure as well as ITO-1 layer 83B serving as the vertical sensor and ITO-1 layer 83C serving as a portion of the horizontal sensor in the bridge structure) that is disposed on and in contact with the transparent substrate at the main touch sensor region. The earlier-formed portion is a portion of a two-dimensional touch sensor that detects the touched two-dimensional location and is composed of a conductive material (for example, ITO).

The touch panel further includes: an insulating layer (for example, insulating layer 84A, 84B at the display portion side and insulating layer 84C, 84D at the icon side) that is disposed on and in contact with the paint film layer in the sub touch sensor region, the earlier-formed portion in the main touch sensor region, and the transparent substrate at a portion not provided with the earlier-formed portion in the main touch sensor region; and a later-formed portion (for example, ITO-2 layer 86A serving as the horizontal sensor in the two-layer structure as well as ITO-2 layer 86B, which is the remaining portion of the horizontal sensor in the bridge structure, serving as the bridge) that is disposed on and in contact with the insulating layer in the main touch sensor region. The later-formed portion is a portion of the two-dimensional touch sensor and is composed of the conductive material (for example, ITO). The touch panel further includes a one-layer-structured touch sensor (for example, ITO-2 layer 86C, 86D), the one-layer-structured touch sensor being disposed on and in contact with the insulating layer in the sub touch sensor region and being composed of the conductive material.

Accordingly, the touch panel can be configured such that the main-side insulating layer and the sub-side insulating layer can be formed in the same step and the later-formed portion and the one-layer-structured touch sensor can be formed in the same step because the paint film layer having the icon drawn is provided in the sub touch sensor region, the sub-side insulating layer is provided between the paint film layer and the one-layer-structured touch sensor, the sub-side insulating layer is in contact with the layer of the one-layer-structured touch sensor, the main-side insulating layer is in contact with the later-formed portion, the main-side insulating layer and the sub-side insulating layer are composed of the same material, and the layer of the one-layer-structured touch sensor and the later-formed portion are composed of the same material.

In this way, the insulating layer can be provided between the paint film layer and the one-layer-structured touch sensor and no additional step is required in providing the insulating layer. As a result, the manufacturing cost can be suppressed from being increased while preventing an operation failure due to the paint film layer.

(3-5) An electric device (for example, smartphone 1) includes any one of the touch panels described above.

Accordingly, there can be provided an electric device including the touch panel, by which the manufacturing cost can be suppressed from being increased while preventing an operation failure due to a paint film layer.

The following describes a modification of the above-described embodiment.

(1) In the embodiment described above, display portion side touch sensor region 61 and icon side touch sensor regions 71A to 71C are provided. However, the present invention is not limited to this. Any touch sensor regions may be employed as long as a plurality of touch sensor regions are provided on one transparent substrate.

(2) In the embodiment described above, it has been illustrated that the invention of the layer structure is applied to a sensor that detects a touch by means of a change in capacitance. However, the invention of the layer structure may be applied not only to the capacitance type sensor but also to a different type of sensor as long as it has a similar structure.

(3) The structure of the one-layer-structured touch sensor in the embodiment described above may be constructed of one region or a plurality of regions. Examples of the structure constructed of one region include: a structure of a rectangular shape; a structure of a circular shape; a structure of a shape obtained by rounding the corners of a rectangle; and a structure of a shape obtained by forming a spiral using a line having a predetermined width. Examples of the structure constructed of the plurality of regions includes: a structure having a shape such that another region is formed to surround one region; and a structure having a shape such that two regions are intertwined.

The embodiments disclosed herein are illustrative and non-restrictive in any respect. The scope of the present invention is defined by the terms of the claims, rather than the embodiments described above, and is intended to include any modifications within the scope and meaning equivalent to the terms of the claims.

### REFERENCE SIGNS LIST

1: smartphone; 5: display portion; 7A-7C, 107, 107A: icon portion; 11: housing; 50, 150A: liquid crystal panel; 51, 151: transmission region; 60, 60A, 60B, 160, 160A, 160B, 161A: touch panel; 61: display portion side touch sensor region; 62: ACF region; 63, 163A, 163B, 173B: FPC; 65, 165A: cabinet; 66: illuminated range; 67: connection portion; 71A-71C: icon side touch sensor region; 72, 172A, 172B: LED; 81A, 81B, 181A, 181B: glass substrate; 82A, 82B, 182A, 182B: BM layer; 83A, 83B, 83C, 183A, 183B, 183C: ITO-1 layer; 84A, 84B, 84C, 84D, 88A, 88B: insulating layer; 86A, 86B, 86C, 86D, 186A: ITO-2 layer; 87A, 87B, 187A, 187B: metal interconnection; 161: touch sensor region; 174B: light guiding member.

1. A touch panel comprising:
one transparent substrate,
said transparent substrate including
a main touch sensor region for detecting a touched two-dimensional location, said main touch sensor region including a two-dimensional touch sensor that detects the touched two-dimensional location, and
at least one sub touch sensor region for detecting whether or not a touch has been done, said sub touch sensor region including a one-layer-structured touch sensor.

2. The touch panel according to claim 1, wherein:
said one-layer-structured touch sensor is composed of a conductive material,
the touch panel further comprises a layer structure on said transparent substrate at said sub touch sensor region, said transparent substrate, a paint film layer, a sub-side insulating layer, and a layer of said one-layer-structured touch sensor being provided in said layer structure in this order, and
said paint film layer is a layer having an icon drawn using a paint material containing a conductive substance.

3. The touch panel according to claim 2, wherein
said two-dimensional touch sensor includes a vertical sensor composed of said conductive material, a horizontal sensor composed of said conductive material, and a main-side insulating layer for providing insulation between said vertical sensor and said horizontal sensor,
said sub-side insulating layer is in contact with the layer of said one-layer-structured touch sensor,
said main-side insulating layer is in contact with a later-formed portion of portions included in said two-dimensional touch sensor, said later-formed portion being formed after said main-side insulating layer,
said main-side insulating layer and said sub-side insulating layer are composed of the same material, and
the layer of said one-layer-structured touch sensor and said later-formed portion are composed of the same material.

4. A touch panel comprising:
one transparent substrate, said transparent substrate including a main touch sensor region for detecting a touched two-dimensional location and at least one sub touch sensor region for detecting whether or not a touch has been done;
a paint film layer that is disposed on and in contact with said transparent substrate at said sub touch sensor region and that has an icon drawn using a paint material containing a conductive substance;
an earlier-formed portion that is disposed on and in contact with said transparent substrate at said main touch sensor region, said earlier-formed portion being a portion of a two-dimensional touch sensor that detects the touched two-dimensional location and being composed of a conductive material;
an insulating layer that is disposed on and in contact with said paint film layer in said sub touch sensor region, said earlier-formed portion in said main touch sensor region, and said transparent substrate at a portion not provided with said earlier-formed portion in said main touch sensor region;
a later-formed portion that is disposed on and in contact with said insulating layer in said main touch sensor region, said later-formed portion being a portion of said two-dimensional touch sensor and being composed of said conductive material; and
a one-layer-structured touch sensor, said one-layer-structured touch sensor being disposed on and in contact with said insulating layer in said sub touch sensor region and being composed of said conductive material.

5. An electric device comprising the touch panel recited in claim 1.
